(19) United States
(12) Patent Application Publication
(10) Pub. No.: US 2007/0240108 A1
(43) Pub. Date: Oct. 11, 2007

(54) Multiclient framework for downloadable highly interactive n-layer medical applications

(76) Inventors: Karlheinz Dorn, (US); Hans-Martin Von Stockhausen, (US)

Correspondence Address: BRINKS HOFER GILSON & LIONE, P.O. BOX 10395, CHICAGO, IL, 60610, US

(21) Appl. No.: 11/393,974

(22) Filed: Mar. 30, 2006

(51) Int. Cl. G06F 9/44

(52) U.S. Cl. 717/114

(57) ABSTRACT

A system, method, and program support a flexible framework for providing communications between the layers of a software application. A processing unit is operable to execute a communications API (Applications Program Interface), the communications API virtually or effectively interconnecting presentation logic and business logic associated with a software application. The communications API transparently and interchangeably executes desktop implementation of the software application and a network implementation of the software application. The desktop implementation, the network implementation, and any switching between implementation modes may be transparent to the presentation logic and/or the business logic. The software application may be an n-layer application, and the communications API may arrange the order of the n-layers based upon whether desktop or network implementation is to be employed. The presentation logic and business logic may be associated with different machines located at a distance.

### BACKGROUND

The present embodiments relate generally to software and software applications. In particular, the present embodiments relate to software directed toward both the desktop and network implementation of a software application.

At present, two different possibilities exist for using a software application, such as software applications directed toward facilitating medical workflows. Either the software application is installed and used on a desktop computer, which is the standard mode, or the application is downloaded from a Web server to a client's machine and brought to execution at the client's location. However, applications deployed on desktop computers are commonly written in a different programming language than World Wide Web (“Web”) accessible applications. Hence, when conventional technologies are used, such as those employed by Microsoft, the source code of the application must be set up and maintained in two versions, one associated with desktop use and the other associated with Web use, which increases the costs associated with software setup and maintenance.

Moreover, medical software applications are almost exclusively n-layer applications. With such applications, the determination of a suitable separation of the software layers in Web deployment may be problematic. The separation of the software layers defines which components of the application are executed at the Web server and which are executed at the client's location. However, after a suitable separation of the layers for Web deployment has been determined, the structure of the application may then have to be redesigned differently for desktop use as desktop deployment is fundamentally different from Web deployment.

The fact that desktop applications are typically written in a different programming language than Web applications has created unique problems for the medical industry. The typical frameworks do not support workflows associated with the multiple medical professionals or locations common in the field of medicine.

### BRIEF SUMMARY

By way of introduction, the embodiments described below include methods, processes, apparatuses, instructions, or systems for providing a flexible framework for virtually connecting presentation logic associated with a software application with business logic associated with the same software application. From a software user's and/or developer's point of view, the flexible framework transparently and interchangeably execute a desktop implementation of the software application and a network or Web implementation of the software application. In one embodiment, the flexible framework is a multiclient framework for downloading highly interactive n-layer applications, including medical applications. Depending upon whether desktop or network implementation is to be employed, the flexible framework also may alter which components/layers of the application are executed on a local machine and which components/layers of the application are executed on a remote machine.

In a first aspect, a data processing system provides a flexible framework for implementing software applications. The system may include a processing unit operable to execute a communications API (Applications Program Interface), the communications API being operable to effectively interconnect presentation logic and business logic associated with a software application. The communications API may be operable to interchangeably execute a desktop implementation of the software application and a network implementation of the software application.

In a second aspect, a method provides a flexible framework for implementing software applications. The method includes employing a communications API (Applications Program Interface) to effectively interconnect presentation logic and business logic associated with a software application. The method also may include interchangeably executing a desktop implementation of the software application and a network implementation of the software application.

In a third aspect, a method provides a flexible framework for implementing software applications. The method includes automatically arranging the order of a multiple layer software application based upon whether desktop implementation or network implementation of the software application is to be employed, the order defining which of the multiple layers of the software application are to be executed at a first location and which of the multiple layers of the software application are to be executed at a second location.

In a fourth aspect, a computer-readable medium having instructions executable on a computer stored thereon is described. The instructions include executing a communications API (Applications Program Interface) and effectively interconnecting presentation logic and business logic associated with a software application via the communications API. The instructions also may include interchangeably executing a desktop implementation of the software application and a network implementation of the software application.

In a fifth aspect, a computer-readable medium having instructions executable on a computer and stored thereon is described. The instructions include effectively interconnecting presentation logic and business logic associated with a software application and means for transparently and interchangeably executing a desktop implementation of the software application and a network implementation of the software application.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The present embodiments will become more fully understood from the detailed description given herein below and the accompanying drawings which are given by way of illustration only, and are not limitative of the present invention, and wherein:

FIG. 1 is a block diagram of a framework for a software application during desktop use;

FIG. 2 is a block diagram of a framework for a software application during Web use;

FIG. 3 is an exemplary method for providing a flexible framework for implementing software applications;

FIG. 4 is a block diagram of an exemplary flexible framework for both desktop and network implementation of a software application;

FIG. 5 is an exemplary user interface;

FIG. 6 is a block diagram of another exemplary flexible framework for both desktop and network implementation of a software application; and

FIG. 7 is an exemplary data processing system.

### DETAILED DESCRIPTION OF THE DRAWINGS AND PRESENTLY PREFERRED EMBODIMENTS

A system, method, and software code provide a flexible framework for virtually interconnecting presentation logic associated with a software application and business logic associated with the same software application. The flexible framework transparently and interchangeably executes a desktop implementation of the software application and a network or Web implementation of the software application. The flexible framework may employ a single code base for both deployment scenarios. For instance, the same binaries, routines, and/or other portions of code may be used in both deployment scenarios. Alternatively, the flexible framework may interchangeably and transparently execute a first instruction set for desktop implementation of the software application and a second instruction set for network or Web implementation of the software application. Other flexible frameworks may be used.

The presentation logic may be executed at one location on a first machine and the business logic may be executed at another location on a second machine. The flexible framework may arrange the order of a multiple layer software application based upon whether desktop or network implementation is to be employed. The order may define which layers or components of the software application are to be executed on the first machine and which layers or components of the software application are to be executed on the second machine. In one embodiment, the flexible framework is a multiclient framework for downloading highly interactive n-layer applications. Highly interactive applications may involve the alteration and presentation of image and other data to facilitate a workflow, such as highly interactive applications that support clinical workflows.

The flexible communications layer may enhance the workflow of software users, such as medical personnel, as well as alleviate programming difficulties for application developers. For instance, until now, a distinction has been made between desktop computer and Web software applications. Typically, two different source code strains had to be developed and monitored when an application was intended for both desktop use and network use.

Conventional medical applications designed for desktop use usually have been developed in the C++ programming language. Such applications are not suited for network use. To make the functionality of such an application available over a network, such as the Internet, reprogramming the application in a different programming language is required, which represents an immense expenditure of time and money. Accordingly, in practice, applications are not commonly reprogrammed, and usually at the very most, only a portion of an application would actually be reprogrammed in a programming language suitable for network use.

However, by the development of a framework that is based upon Microsoft .NET technology and a flexible communications layer for communication between the layers of a multiple layer application, it becomes possible to develop software applications, including medical applications, which are suitable for both desktop and Web use. An application developer employing the framework no longer has to address the question of whether his or her application can be used for both desktop and network uses. The framework guarantees that a software application can run in both desktop mode and Web mode, eliminating any need to alter the application or reprogram the application in a different programming language.

The flexible communications layer can determine the use, desktop or Web, for which the application is currently being used. After which, the flexible communications layer may arrange two or more layers of the n-layer application in a specific order, such that the actual use environment of the application may remain concealed from the application. In other words, the application can function identically or similarly whether it is being employed for desktop or network use and the mode of implementation, desktop or network, remains transparent to the application, as well as the application developer that develops the code.

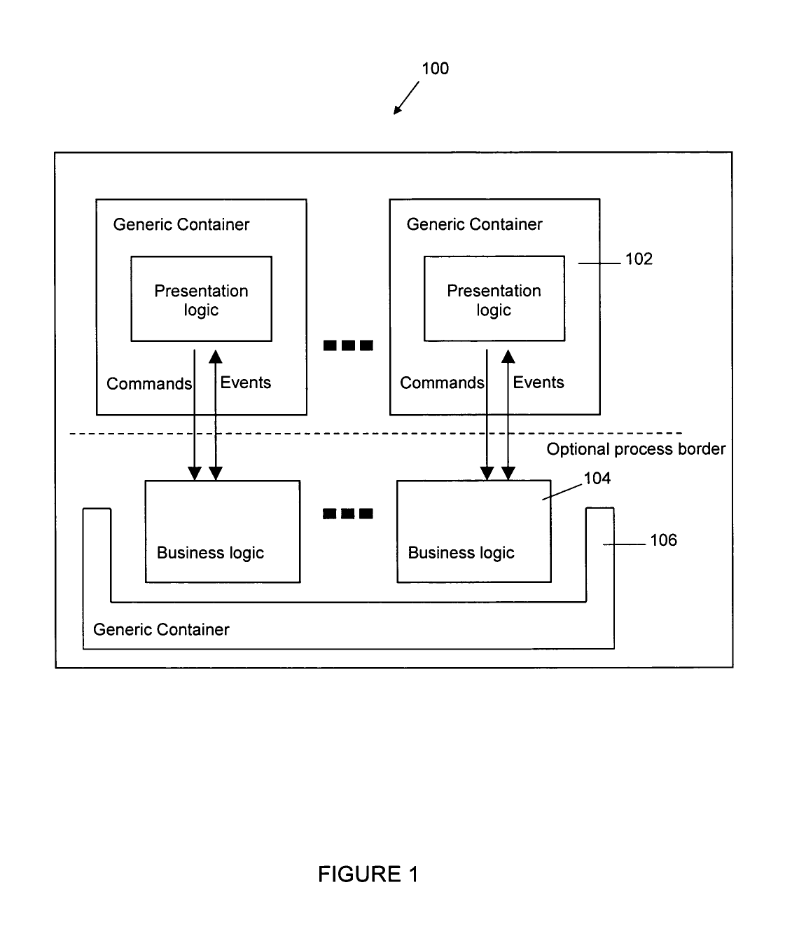

FIG. 1 illustrates a framework for software applications during desktop use 100. A number of desktop computers 102 may be interconnected via a standard local network having a backend 104 and a main 106. The backend 104 may consist of software that virtually interconnects all of the desktop computers 102 associated with the local network. The main 106 may be hardware, such as a main frame or server, that executes the backend 104 and/or other software. The framework for software applications during desktop use 100 may include additional, fewer, or alternate components.

As shown in FIG. 1, each desktop computer 102 may be operable to store locally and/or execute presentation logic associated with an application. The desktop computer 102 may communicate with the main 106 via commands and events. The main 106 may be operable to store locally and/or execute business logic associated with the application. As illustrated, a virtual processing border may be established between the desktop computers 102 and the main 106. Other interrelationships may be used.

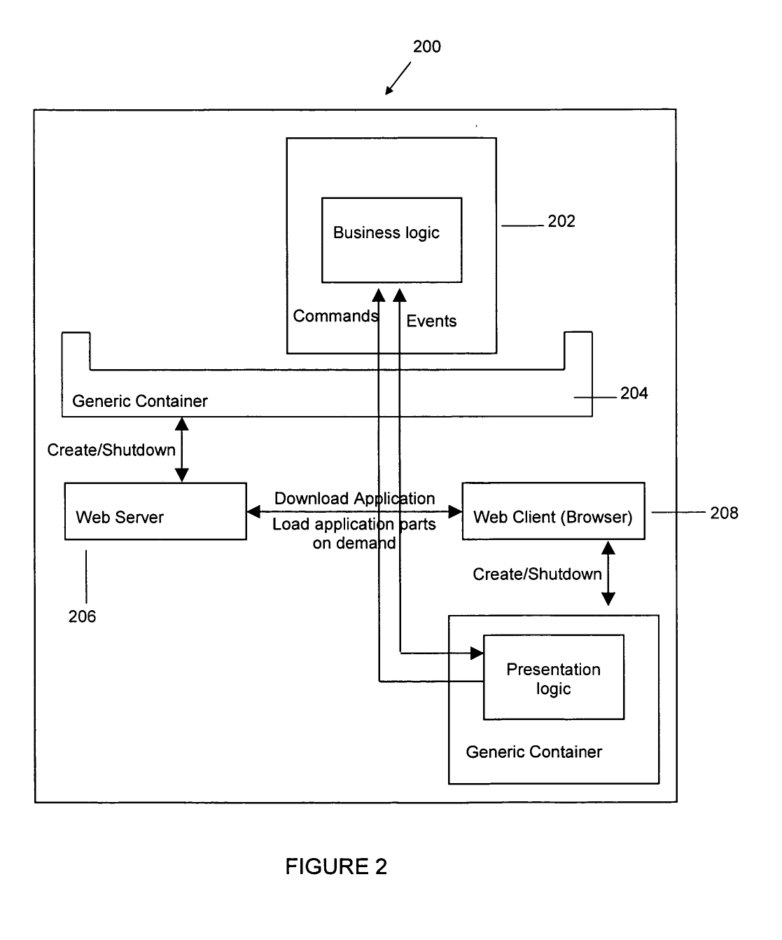

FIG. 2 illustrates a framework for software applications during Web or network use 200. The framework 200 may include desktop computers 202, a main 204, a Web server 206, and a Web browser 208. The framework for software applications employed during Web use 200 may include additional, fewer, or alternate components.

A number of desktop computers 202 may be interconnected via a main 204 to form a local network. The desktop computers 202 may be standard desktop computers, laptops or other portable computers, PDAs or other hand held computing devices, computer terminals, or other processing devices. The main 204 may comprise either software and/or hardware that operates to effectively interconnect the desktop computers 202 into a local network.

The local network may be interconnected with the Web server 206. The Web server 206 may be either software and/or hardware that provides for communication from the local network to a Web browser 208. For instance, the Web server 206 may permit interconnectivity between one or more of the desktop computers 202 with the Internet or another non-local communications network.

The Web server 206 and Web browser 208 may operate independently or together. The Web server 206 and/or Web browser 208 may permit the download of software applications from a remote location/machine to the local network and/or desktop computers 202, and/or the download of parts of software applications, such as layers and/or revised portions, on demand. The Web server 206 and/or Web browser 208 may act as a conduit for viewing software applications whose business logic is primarily executed on a remote machine and whose presentation logic is primarily executed locally. The framework for the software application employed during Web use may include additional, fewer, or alternate components.

As shown in FIG. 2, each desktop computer 202 may be operable to store locally and/or execute business logic associated with an application. The desktop computer 202 may communicate with the main 204 via commands and events. The main 204 may be operable to store locally and/or execute presentation logic associated with the application. Alternatively, the presentation logic may executed by the desktop computer 202 and the business logic executed by the main 204. Other frameworks may be used.

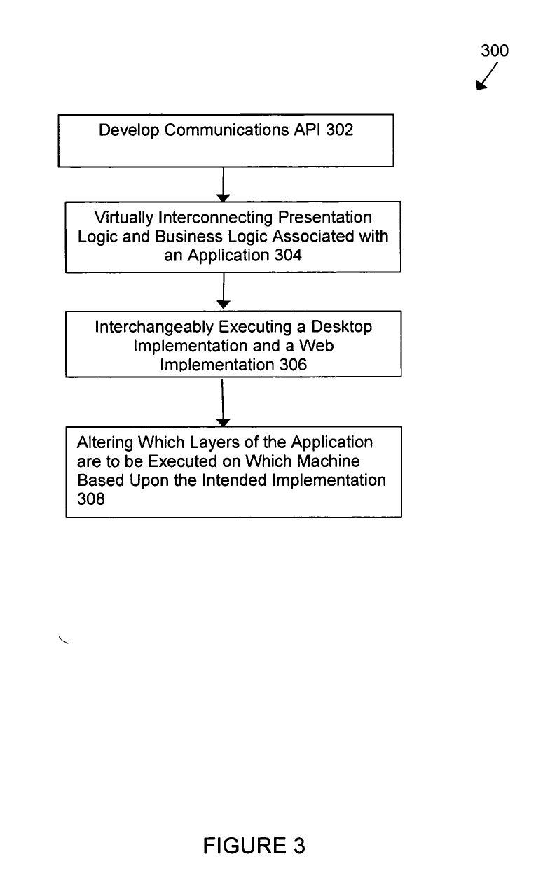

FIG. 3 illustrates an exemplary method for providing a flexible framework for implementing software applications 300, which may be facilitated by a data processing system. The method may include developing a communications API (Applications Program Interface) 302, virtually interconnecting presentation logic and business logic associated with a software application 304, and interchangeably executing a desktop deployment and a Web deployment of the software application 306. The method also may include altering which layers/components of the software application are to be executed on a local machine and which layers/components are to be executed on a remote machine based upon the intended implementation 308, or other factors, including but not limited to the hardware and/or software capabilities associated with either a local or remote location, or both. The method may include additional, fewer, or alternate actions.

Developing the communications API 302 may include programming or otherwise developing the communications API itself, along with programming or otherwise developing a single code base or instruction set that facilitates both a desktop use of the application and a Web use of the application. The desktop use and the Web use may be interchangeably and transparently executed from the viewpoint of a user. Alternatively, developing the communications API 302 may include programming or otherwise developing a first instruction set to facilitate desktop use of the application and a second instruction set to facilitate Web use of the application. The first and second instruction sets also may be interchangeably and transparently executed from the viewpoint of a user. Developing the communications API 302 may include additional, fewer, or alternate actions.

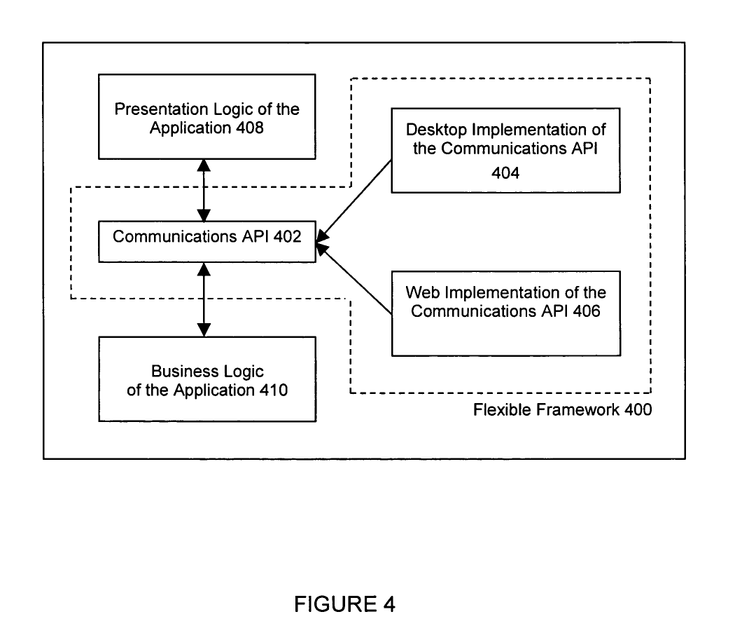

For instance, FIG. 4 is an exemplary embodiment of a flexible framework or communications layer 400. The flexible communications layer 400 may include a communications API (Applications Program Interface) 402, a desktop implementation of the communications API (Applications Program Interface) 404, and a Web or network implementation of the communications API (Applications Program Interface) 406. The flexible communications layer 400 may include additional, fewer, or alternate components.

For virtually, logically, or otherwise effectively interconnecting presentation logic and business logic associated with the application 304, as illustrated in FIG. 4, the flexible communications layer 400 may be in communication with or virtually interconnected with the presentation logic of the application 408 and the business logic of the application 410. The flexible communications layer 400 may be in communication with or virtually interconnected with additional, fewer, or alternate application components.

The presentation logic of the application 408 refers to the processing and code (instructions, routines, etc.) required to display and/or print data. The presentation logic may contain code for generating a virtual display. The display may include a user interface, such as a standard graphical user interface. Hence, the presentation logic may contain code for executing the user interface, such as generating windows, screens, buttons, menus, icons, etc. The user interface may accept input or commands from a user in a number of manners, such as via keyboard, mouse, touch screen, touch pads, voice recognition, haptic controls or other vibration/feedback means, or other input means.

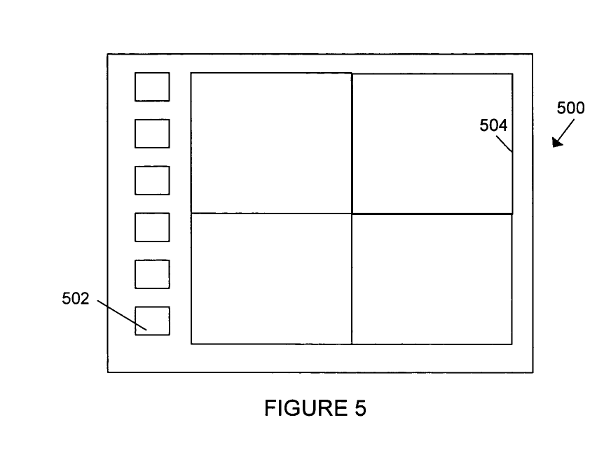

In one embodiment, the presentation logic may include instructions for displaying images received from one or more medical devices on a single display. FIG. 5 illustrates an exemplary user interface 500 for displaying images and other information to a user. As shown, the user interface 500 may include one or more icons 502 and one or more windows 504. The user interface 500 may include additional, fewer, or alternate components.

Each icon 502 may be associated with a different function. An operation performed on an icon 502, such as by a mouse, touch screen, or other input device, may result in the images and/or data displayed in the window 504 being changed.

The business logic of the application 410 may contain code primarily for performing processes via a processor, exclusive of the presentation logic (the code primarily related to the user interface). In general, business logic is a term of art used in software architecture to signify a software component, layer or tier of software functionality, software library or the like that primarily performs operations on some kind of data passed back and forth through it. The business logic may include routines that perform data entry, update, query and report processing, as well as the processing that occurs “behind the scenes” as compared to the previously discussed presentation logic, which is primarily associated with graphical user interface processing and that is required to display images and data on a display screen.

Accordingly, business logic may primarily refer to the logic that embodies business rules rather than the presentation of information. In one embodiment, the business logic may be primarily directed to receiving, storing, and analyzing medical data, such as medical image data, and facilitating medical diagnosis. For example, the business logic provides medical image processing, measurement extraction, diagnosis assistance or patient record collection.

The method 300 also may include transparently and interchangeably executing a desktop implementation of an application and a Web implementation of the application 306. FIG. 4 illustrates a desktop use of the application 404 and a Web use of the same application 406. The flexible framework may transparently and interchangeably execute both implementations based upon the intended use of the application.

To help illustrate, FIGS. 1 and 2 together show that the mode of implementation, whether desktop or Web, is transparent to the software application. Either the application can be made to run in a container, as shown in FIG. 1, or the application may be brought to execution in some other container running in a Web or other network server, as shown in FIG. 2. The interaction of the application with the container, however, remains the same regardless of which type of container is used.

As a result, the application software itself need not change in different deployments and may be run unmodified in both desktop and Web deployment. Additionally, neither the presentation logic, the business logic, nor communication interfaces need to change when the environment of the application is changed. Therefore, in general, the application architecture and the programming language in which the application is programmed may remain the same.

Individually, the application layers communicate via a defined communications layer. This communications layer offers the application developer a defined API. If the application is currently intended for desktop use, a defined implementation suitable for desktop use of the communications API is employed. Conversely, if the application is currently intended for network use, a different implementation suitable for network use of the communications API is employed. Because the communication between application layers may always be done via the communications API, it is possible to exchange the implementation of the API in the framework, without any effect on the application. Hence, the mode of implementation of the application, whether desktop or network, may be transparent to both the presentation logic and the business logic associated with the application.

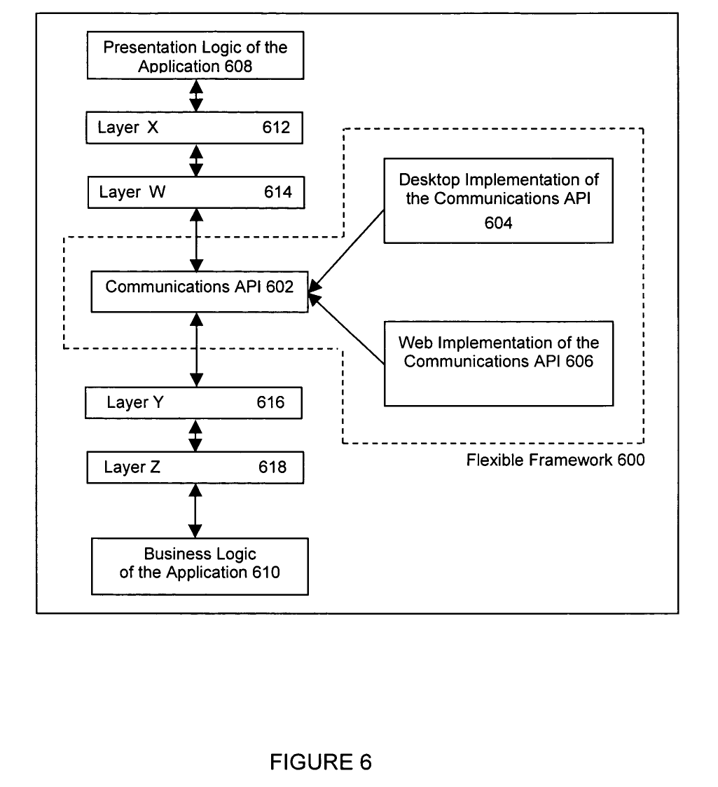

The method may also include altering which layers of a multiple layer application are to be executed on which machines based upon the intended use of the application 308. FIG. 6 is another exemplary embodiment of a flexible framework or communications layer 600. Similar to the framework of FIG. 4, the flexible communications layer 600 may include a communications API (Applications Program Interface) 602, an implementation of the communications API (Applications Program Interface) for desktop use 604, and an implementation of the communications API (Applications Program Interface) for Web or network use 606. The flexible communications layer 600 may include additional, fewer, or alternate components.

The flexible communications layer 600 may be in communication with or interconnected with the presentation logic of the application 608 and the business logic of the application 610. The flexible communications layer 600 may be in communication with or interconnected with additional, fewer, or alternate components.

For instance, the application may be a multiple layer application. The application may consist of one or more layers of software that primarily represent the presentation logic 608, one or more layers of software that primarily represent the business logic 610, and one or more additional layers/components of software 612, 614, 616, 618 that may be associated with either the presentation logic, the business logic, or other functionality. As such, the flexible communications layer 600 may be in communication with one more layers 612, 614, 616, 618 of the application, in addition to code representing the primary or core presentation and business logic 608, 610.

In one embodiment, the presentation logic may be executed on a first machine located at a first location and the business logic may be executed on a second machine located at a second location. The flexible framework 600 may automatically determine the separation point between the layers of the applications, the separation point defining where and on what machine each of the layers are to be executed. In other words, the flexible framework 600 may automatically alter/arrange the virtual order of the application such that different layers may be executed via different machines based upon whether the currently intended mode is for desktop or Web deployment. The flexible framework 600 itself may be executed at either the first or second location.

The automatic determination of which layers are to be performed on which machine may be based upon other factors, such as the execution time and processing power of various machines and network bandwidth associated with a first location and a second location. For instance, the flexible framework 600 may be intended to support multiple clients. An n-layer application, or various layers thereof, may be available for download via the Internet or other network. The n-layer application may have one or more layers that are capable of being performed at either the local (for example, the client) or remote (for example, the software provider) location.

However, each client may have different network, server, hardware, software, and/or other technological capabilities and limitations associated with their local machines and/or internal network/intranet. Accordingly, with clients having more up-to-date or complex systems, such as more sophisticated local hardware and/or software capabilities, computing efficiency may be enhanced if one or more layers of an n-layer software application are executed locally at the client's location rather than remotely, such as at the software provider's location.

On the other hand, with clients that possess less sophisticated or complex hardware and/or software, computing efficiency may be enhanced if one or more layers of the n-layer application are executed at a remote location, such as at the software provider's location. In other words, in all likelihood, the computing efficiency of the hardware/software at the client's location and at a remote location, such as associated with a remote server and/or computer located at the location from which the software transmission originates, will not be identical. Hence, based upon client technology, the number of software layers performed locally and the number of software layers performed remotely may be altered to enhance the overall computing efficiency and take advantage of the hardware/software/network combination that may provide the optimum computing system.

The system, method, and software instructions discussed herein may permit a clinical workflow to initiate by a user at a medical facility using a desktop implementation of the software application. The clinical workflow may be suspended and subsequently restarted, such as at the step in the workflow where the workflow was previously suspended, by the same or a different user located at a remote location using a different computer, such as via a lap top computer, and using a Web implementation of the software application. Furthermore, the clinical workflow may be again suspended and subsequently restarted, such as at the step in the workflow where the workflow was suspended a second time, by the same or a different user located at the medical facility, another remote location, or other location, using the software in either desktop or Web mode.

Alternatively, the system, method, and software instructions discussed herein may permit a clinical workflow to be initiated by a user at a remote location using a Web implementation of the software application, such as via a computer connected to the Internet. The clinical workflow may be suspended and subsequently restarted, such as at the step in the workflow where the workflow was previously suspended, by the same or a different user located at the same or a different remote location or at a medical facility.

In one embodiment, a workflow may be started offline, i.e., not connected to a network, such as at either a local or remote location, and then subsequently the workflow may be continued online, i.e., connected to a network, at either the original location or a different location. In another embodiment, a workflow may be started online, such as at either a local or remote location, and then subsequently the workflow may be continued offline, at either the original location or a different location. In either case, the user may continue the workflow from the step that the workflow was previously halted with or without downloading additional layers of code, such as layers of business or presentation logic. Additionally, any work performed offline, may be synchronized or other wise harmonized with other work performed online after accessing a network, such as the Internet. Other scenarios may be employed.

For instance, in the case that the workflow is started online and subsequently continued offline, there may be a need to download additional business logic to the client machine due to requirements associated with on-demand deployment. In some situations, a client starting an online workflow will only download portions of software, such as portions of presentation logic, that are required for the next step in the workflow. If at some point in time the user determines to continue the workflow offline, the client may need to download the presentation logic for the remaining tasks in the workflow, as well as any business logic that would have been executed on a server in the online scenario.

Alternatively, the entire business and presentation logic may initially be cached on the client machine. However, the first time a workflow is used, the client may not have access to or permission to use all of the business and/or presentation logic without first obtaining a password or other key. On the other hand, if the workflow is started offline, all of the required code already may be available on and/or accessible via the client machine. As such, the need to download additional software may be alleviated for the offline scenario.

The system, method, and software instructions discussed herein may facilitate the same source code executing different deployment scenarios of an application, such as the remote and local implementation of an application. As a result, the use of multiple versions of source code and/or multiple machines to support different deployment scenarios may be alleviated.

Additionally, as shown in FIG. 6, different tiers or layers of a software application may be downloaded to a client location. Each of the different layers may be associated with business logic or presentation logic. An intelligent strategy of downloading the software layers may be employed. For instance, during use, only the layers currently required by a software application may be downloaded, which may enhance the efficiency of the system. The system may identify which layers of code a client wants, needs to run an application, or has signed up for. Based upon that determination, different layers of business logic and/or presentation logic may be automatically downloaded to a client's location. Other strategies for downloading various layers of software may be employed.

Shown in Table I below is one embodiment of software code used to employ the communications API of the flexible communications layer. Additional, less, or alternate software code may used. The communications API code may be written in alternate programming languages.

The software code in Table I below associated with the communications API provides a means for transparently and interchangeably executing a desktop implementation of a software application and a network implementation of the software application. Additionally, the code below may be used in conjunction with other code that performs the instructions and functions as discussed herein, including code that effectively interconnects presentation logic and business logic associated with a software application where the presentation logic and business logic are located on different machines. In one embodiment, the code below is associated with the communications API 402 of the flexible communications layer 400 of FIG. 4 which may determine what type of use an application is in at the moment, as well as arrange the layers of the application to determine which layers are executed on each machine, such that the actual use environment of the application remains concealed from the application.

TABLE I
Means for Interchangeably Exchanging Implementations

public interface ICmdServer

{

int InitServerWorkingBox ( );
bool ExitServerworkingBoxes ( );
string InitServerCommandChannel (string theChannel,

string theCmdType,
string theCmdDescr,
int theWBoxID);

bool ExitServerCommandChannel (string theCmdID);

}

public interface ICmdClient

{

void SendEvent (string theEventChannelPattern, string theEventString);
bool WaitCommand (string theCmdPattern, string cmdId, int theTimeOut);
bool ResumeCommand (string theCmdPattern, string cmdId);
bool SuspendCommand (string theCmdPattern, string cmdId);
bool ExitEventChannel (string theEventChannelPattern);
bool InitEventChannel (string theEventChannelPattern);
string InitClientCommandChannel (string channelName);
bool ExitClientCommandChannel (string channelId);
string ExecuteCommand WithData (string channelId,

string proxy_in,
string mode_in);

bool CancelCommand (string channelId, string commandId);
string UserToken
{

set;

}
string PreTag
{

set;

}
event CommandReplyDelegate CommandReplyEvent;
event ATEventDelegate ATEvent;

}

public interface ICommunicationMediator : ICmdClient, ICmdServer

{

CommunicationType CommunicationMode
{

set;

}

}

public enum CommunicationType

{

Classic,
WebEnabled,

} ;

public class CommunicationMediator : ICommunicationMediator

{

private CmdClass myCmd = null;
private CmdClass Cmd
{

get
{

if (myCmd = = null)
{

try
{

myCmd = new CmdOCXLib.CmdClass( );

}
catch (Exception e)
{

Trace.Warn(this, “Failed to create Cmd.ocx”

, e);

}

}
return myCmd;

}

}
private CommunicationType myCommunicationMode =

CommunicationType.Classic;

public CommunicationType CommunicationMode
{

set
{

myCommunicationMode = value;

}

}

public int InitServerWorkingBox ( )
{

int aWorkingBoxID = −1;
if (myCommunicationMode = = CommunicationType.ClassicCmd)
{

if (Cmd != null)
{

if (!Cmd.initServerWorkingBox (ref

aWorkingBoxID))

{

throw new Exception (“WorkingBox hasn't

been created”);

}

}

}
return aWorkingBoxID;

}
public string InitServerCommandChannel (string theChannel,

string theCmdType,
string theCmdDescr,
int theWBoxID)

{

string aCmdID = “”;
if (myCommunicationMode = = CommunicationType.ClassicCmd)
{

if (Cmd != null)
{

aCmdID = Cmd.InitServerCommandChannel

(theChannel,
theCmdType,
theCmdDescr,
theWBoxID);

}

}
return aCmdID;

}
public void SendEvent (string theEventChannelPattern, string

theEventString)

{

if (myCommunicationMode = = CommunicationType.ClassicCmd)
{

if (Cmd != null)
{

Cmd.sendEvent (theEventChannelPattern,

theEventString);
}

}

}

public bool WaitCommand (string theCmdPattern, string cmdId, int

theTimeOut)

{

bool aRetVal = false;
if (myCommunicationMode = = CommunicationType.ClassicCmd)
{

if(Cmd != null)
{

aRetVal = Cmd.waitCommand (theCmdPattern,

cmdId, theTimeOut);
}

}
return aRetVal;

}
public bool ResumeCommand (string theCmdPattern, string cmdId)
{

bool aRetVal = false;
if (myCommunicationmode = = CommunicationType.ClassicCmd)
{

if(Cmd != null)
{

aRetVal = Cmd.resumeCommand (theCmdPattern,

cmdId);

}

}
return aRetVal;

}
public bool SuspendCommand (string theCmdPattern, string cmdId)
{

bool aRetVal = false;
if (myCommunicationMode = = CommunicationType.ClassicCmd)
{

if (Cmd != null)
{

aRetVal = Cmd.suspendCommand (theCmdPattern,

cmdId);

}

}
return aRetVal;

}
public bool ExitEventChannel (string theEventChannelPattern)
{

bool aRetVal = false;
if (myCommunicationMode = = CommunicationType.ClassicCmd)
{

if(Cmd != null)
{

aRetVal = Cmd.exitEventChannel

(theEventChannelPattern);

}

}
return aRetVal;

}
public bool InitEventChannel (string theEventChannelPattern)
{

bool aRetVal = false;
if (myCommunicationMode = = CommunicationType.ClassicCmd)
{

if(Cmd != null)
{

aRetVal = Cmd.initEventChannel

(theEventChannelPattern);

Cmd.eventHandler += new

_DCmdEvents_eventHandlerEventHandler (ATEventHandler);

}

}
return aRetVal;

}
private void ATEventHandler (string channel, string evt, string userId)
{

if (ATEvent != null)
{

ATEvent(channel, evt, userId);

}

}
public bool ExitServerWorkingBoxes ( )
{

bool aRetVal = false;
if (myCommunicationMode = = CommunicationType.ClassicCmd)
{

if(Cmd != null)
{

aRetVal = Cmd.exitServerWorkingBoxes( );

}

}
return aRetVal;

}
public bool ExitServerCommandChannel (string theCmdID)
{

bool aRetVal = false;
if (myCommunicationMode = = CommunicationType.ClassicCmd)
{

if (Cmd != null)
{

aRetVal = Cmd.exitServerCommandChannel

(theCmdID);

}
}
return aRetVal;

}
public string InitClientCommnandChannel (string channelName)
{

string aChannelID = “”;
if (myCommunicationMode = = CommunicationType.ClassicCmd)
{

if(Cmd != null)
{

aChannelID = Cmd.initClientCommandChannel

(channelName);

Cmd.returnEventWithDataHandler += new

_DCmdEvents_returnEventWithDataHandlerEventHandler (ReplyEventHandler);

}

}
return aChannelID;

}
private void ReplyEventHandler (string channelId, string commandId, string

cmd, string userId)

{

if (CommandReplyEvent != null)
{

CommandReplyEvent (channelId, commandId, cmd, userId);

}

}
public bool ExitClientCommandChannel (string channelId)
{

bool aRetVal = false;
if (myCommunicationMode = = CommunicationType.ClassicCmd)
{

if (Cmd != null)
{

aRetVal = Cmd.exitClientCommandChannel

(channelId);

}

}
return aRetVal;

}
public string ExecuteCommandWithData (string channelId,

string proxy_in,
string mode_in)

{

string aCmdID = “”;
if (myCommunicationMode = = CommunicationType.ClassicCmd)
{

if (Cmd != null)
{
aCmdID = Cmd.executeCommandWithData

(channelId, proxy_in, mode_in);

}

}
return aCmdID;

}
public bool CancelCommand (string channelId, string commandId)
{

bool aRetVal = false;
if (myCommunicationMode = = CommunicationType.ClassicCmd)
{

if (Cmd != null)
{

aRetVal = Cmd.cancelCommand (channelId,

commandId);

}

}
return aRetVal;

}
public string UserToken
{

set
{

if (myCommunicationMode = =

CommunicationType.ClassicCmd)

{

if(Cmd != null)
{

Cmd.UserToken = value;

}

}

}

}
public string PreTag
{

set
{

if (myCommunicationMode = =

CommunicationType.ClassicCmd)

{

if (Cmd != null)
{

Cmd.PreTag = value;

}

}

}

}
public event CommandReplyDelegate CommandReplyEvent;
public event ATEventDelegate ATEvent;
}

### I. Additional Exemplary Embodiments

Software based upon the framework that provides a flexible communication layer, as described herein, is usable for both desktop and Web use. Moreover, the framework makes interruptions in the clinical workflow possible. The application may be directed toward various medical applications and supporting the software needs of multiple clients. For instance, the presentation logic may be directed toward enhancing a medical workflow by displaying patient monitoring information, two or three dimensional medical images, electro-anatomical mapping or computed tomography/magnetic resonance images, and/or other information.

The business logic also may be directed toward to enhancing a medical workflow. For instance, the business logic may be directed toward supporting an electrophysiology workflow, an x-ray fluoroscopy, intra-cardiac (IC) echo, cardiac electro-anatomical (EA) mapping, or catheter ablation workflow. The presentation and business logic may be directed toward additional, fewer, or alternate medical workflows.

The presentation logic and/or business logic may perform operations related to navigation, image and data fusion, pre-interventional computed tomography and/or magnetic resonance, electro-anatomical mapping, two and/or three dimensional intra-cardiac echos, two and/or three dimensional x-ray images, Leonardo workstations, and/or other functionality. Additionally, the medical workflows may be facilitated by machines interconnected via high speed data lines, wireless transmission, modem, computer network, common database, bus, or other means of transmission.

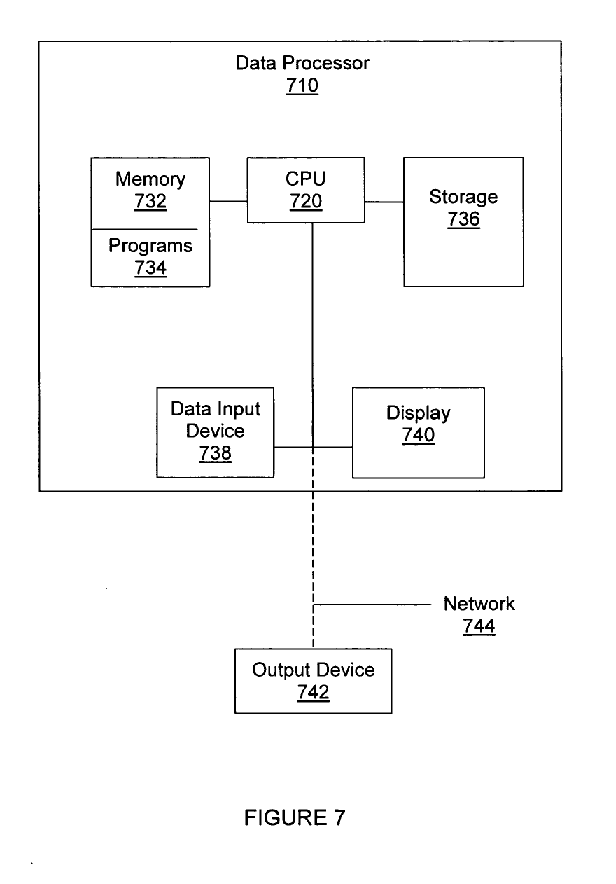

FIG. 7 is a block diagram of an exemplary data processor 710 configured or adapted to provide functionality for providing a flexible framework for implementing software applications. The data processor 710 may include a central processing unit (CPU) 720, a memory 732, a storage device 736, a data input device 738, and a display 740. The data processor 710 also may have an external output device 742, which may be a display, a monitor, a printer and/or a communications port. The data processor 710 may be a personal computer, work station, server, medical device, or other system. The data processor 710 may be interconnected to a network 744, such as an intranet, the Internet, or an intranet connected to the Internet. The data processor 710 may be interconnected to another location via the network 744 either by data lines or by wireless communication. The data processor 710 may direct that the data received be stored on or read from machine-readable medium, including secondary storage devices such as hard disks, floppy disks, CD-ROMS, and DVDs; electromagnetic signals; or other forms of machine readable medium, either currently known or later developed. The data processor 710 is provided for descriptive purposes and is not intended to limit the scope of the present system. The data processor may have additional, fewer, or alternate components.

A program 734 may reside on the memory 732 and include one or more sequences of executable code or coded instructions that are executed by the CPU 720. The program 734 may be loaded into the memory 732 from the storage device 736. The CPU 720 may execute one or more sequences of instructions of the program 734 to process data. The program 734 may provide workflow assistance and functionality as discussed herein.

As shown in FIG. 7, the program 734 may permit a user to enter data into the data processor 710 via the data input device 738, the network 744, or another input device. After which, the data may be stored in the memory 732, the storage device 736, or other storage unit. Additionally, the data processed by the data processor 710 may be provided as an output to the display 740, the external output device 742, the network 744, and/or stored in a database.

In one embodiment, data may be received via the network 744 or other network with which medical devices are interconnected. The data processor 710 may receive and store the medical data received in the memory 732, the storage device 736, or other storage unit. The program 734 may direct that the data received be stored on or read from machine-readable medium, including secondary storage devices such as hard disks, floppy disks, CD-ROMS, and DVDs; electromagnetic signals; or other forms of machine readable medium, either currently known or later developed.

The data processor 710 may execute a communications API (Applications Program Interface), the communications API being operable to effectively interconnect presentation logic and business logic associated with a software application. The data processor 710 also may be operable to transparently and interchangeably execute a desktop implementation of the software application and a network implementation of the software application. The data processor 710 also may be operable to arrange the order of an n-layer application based upon the factors discussed herein.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

I claim:

1. A data processing system for providing a flexible framework for implementing software applications, the system comprising:
a processing unit operable to execute a communications API (Applications Program Interface), the communications API being operable to effectively interconnect presentation logic and business logic associated with a software application;
wherein the communications API is operable to interchangeably execute a desktop implementation of the software application and a network implementation of the software application.

2. The system of claim 1, wherein the communications API is operable to change between desktop implementation of the software application and network implementation of the software application, the change being transparent to the presentation logic and the business logic.

3. The system of claim 1, wherein the software application is an n-layer application and the communications API is operable to arrange to the order of the n-layers based upon whether desktop implementation or network implementation is to be employed.

4. The system of claim 1, wherein the software application is an n-layer application, the presentation logic is primarily associated with a first machine, the business logic is primarily associated with a second machine, and the communications API is operable to change which layers of the n-layer application are performed on the first machine and on the second machine, respectively, depending upon whether desktop implementation or network implementation is to be employed.

5. The system of claim 1, wherein the presentation logic and the business logic are stored in separate devices and the communications API permits communication between the presentation logic and the business logic.

6. The system of claim 1, wherein the presentation logic is associated with a first machine and the business logic is associated with a second machine, and the communications API is associated with either the first or second machine.

7. The system of claim 1, wherein the presentation logic and business logic are directed to a medical application and the presentation logic is operable to display medical image data on a screen.

8. The system of claim 7, wherein the presentation logic and business logic enhance a medical workflow associated with x-ray fluoroscopic, intra-cardiac echo, electro-anatomical mapping, ablation catheter, computed tomography, or magnetic resonance devices.

9. The system of claim 1, wherein the network is the Internet.

10. A method for providing a flexible framework for implementing software applications, the method comprising:
employing a communications API (Applications Program Interface) to effectively interconnect presentation logic and business logic associated with a software application; and
interchangeably executing a desktop implementation of the software application and a network implementation of the software application.

11. The method of claim 10, comprising, wherein the software application is a multiple layer application, changing which layers of the software application are performed on a first machine primarily associated with executing the presentation logic and on a second machine primarily associated with executing the business logic, respectively, depending upon whether desktop implementation or network implementation is to be employed.

12. The method of claim 11, wherein the presentation logic and business logic are directed to a medical application and the presentation logic is operable to display medical image data on a screen.

13. The method of claim 10, wherein the execution of both the desktop implementation and the network implementation is transparent to both the presentation logic and the business logic.

14. The method of claim 10, wherein the software application is an n-layer application and the method comprises automatically arranging the order of the n-layers based upon whether desktop implementation or network implementation is to be employed.

15. The method of claim 10, wherein the software application is an n-layer application and the method comprises automatically determining which of the n-layers are performed at a local location and which of the n-layers are performed at a remote location based upon hardware and software capabilities associated with the local location.

16. The method of claim 10, comprising storing the presentation logic on a first machine and the business logic on a second machine, wherein the communications API permits communication between the presentation logic and the business logic.

17. The method for providing a flexible framework for implementing software applications, the method comprising:
automatically arranging the order of a multiple layer software application based upon whether desktop implementation or network implementation of the software application is to be employed, wherein the order defines which of the multiple layers of the software application are to be executed at a first location and which of the multiple layers of the software application are to be executed at a second location.

18. The method of claim 17, wherein the first location is associated with a first machine that processes presentation logic and the second location is associated with a second machine that processes business logic.

19. The method of claim 18, wherein the presentation logic and business logic are directed to a medical application and the presentation logic is operable to display medical image data on a screen.

20. In a computer-readable medium having instructions executable on a computer stored thereon, the instructions comprising:
executing a communications API (Applications Program Interface);
effectively interconnecting presentation logic and business logic associated with a software application via the communications API; and
interchangeably executing a desktop implementation of the software application and a network implementation of the software application.

21. The computer-readable medium of claim 20, wherein the desktop implementation and the network implementation of the software application is transparent to the presentation logic and business logic.

22. The computer-readable medium of claim 20, comprising, wherein the software application is an n-layer application, arranging the order of the n-layers based upon whether desktop implementation or network implementation is to be executed.

23. The computer-readable medium of claim 20, comprising displaying medical image data on a display screen.

24. In a computer-readable medium having instructions executable on a computer stored thereon, the instructions comprising:
effectively interconnecting presentation logic and business logic associated with a software application; and
means for transparently and interchangeably executing a desktop implementation of the software application and a network implementation of the software application.

25. The computer-readable medium of claim 24, wherein the software application is a multiple layer application, the instructions comprising determining which layers are to be executed at a remote server and which layers are to be executed at a client's location.
